(19) United States
(12) Patent Application Publication
(10) Pub. No.: US 2011/0041130 A1
(43) Pub. Date: Feb. 17, 2011

(54) INFORMATION PROCESSING APPARTUS, INFORMATION PROCESSING METHOD AND COMPUTER READABLE MEDIUM

(75) Inventor: Youichi ISAKA, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/726,902

(22) Filed: Mar. 18, 2010

(30) Foreign Application Priority Data
Aug. 17, 2009 (JP) 2009-188389

(51) Int. Cl. G06F 9/46

(52) U.S. Cl. 718/100

(57) ABSTRACT

An information processing apparatus includes: a reliability decision unit that decides reliability, which is required in order to process a processing object, based on the processing object; a processing determination unit that determines whether or not to make a processing subject process the processing object by comparing the reliability determined by the reliability decision unit with reliability of the processing subject; and a processing request unit that requests processing of the processing object to the processing subject when the processing determination unit determines that the processing object is to be processed by the processing subject.

### CROSS-REFERENCE TO RELATED APPLICATIONS

This application is based on and claims priority under 35 USC 119 from Japanese Patent Application No. 2009-188389 filed on Aug. 17, 2009.

### BACKGROUND

### Technical Field

The present invention relates to an information processing apparatus, an information processing method and a computer readable medium.

### SUMMARY

According to an aspect of the invention, an information processing apparatus includes: a reliability decision unit that decides reliability, which is required in order to process a processing object, based on the processing object; a processing determination unit that determines whether or not to make a processing subject process the processing object by comparing the reliability determined by the reliability decision unit with reliability of the processing subject; and a processing request unit that requests processing of the processing object to the processing subject when the processing determination unit determines that the processing object is to be processed by the processing subject.

### BRIEF DESCRIPTION OF THE DRAWINGS

Exemplary embodiment(s) of the present invention will be described in detail based on the following figures, wherein:

FIG. 1 is a view showing the conceptual module configuration in a typical configuration example of various kinds of embodiments;

FIG. 2 is an explanatory view showing an example of service processing when the present embodiment is embodied;

FIG. 3 is an explanatory view showing an example of service processing when the present embodiment is embodied;

FIG. 4 is an explanatory view showing an example of service processing when the present embodiment is embodied;

FIG. 5 is an explanatory view showing an example of service processing when the present embodiment is embodied;

FIG. 6 is an explanatory view showing an example of the data structure of a Web service reliability table;

FIG. 7 is an explanatory view showing an example of the data structure of a security level change table;

FIG. 8 is an explanatory view showing an example of the data structure of a compatible service table;

FIG. 9 is an explanatory view showing an example of the data structure of a service menu correspondence table;

FIG. 10 is a view showing the conceptual module configuration in a main configuration example of a first embodiment;

FIG. 11 is a flow chart showing an example of service processing;

FIG. 12 is a flow chart showing an example of decision processing of a new security level;

FIG. 13 is a flow chart showing an example of decision processing of a new security level;

FIG. 14 is a flow chart showing an example of decision processing of a new security level;

FIG. 15 is a flow chart showing an example of security determination processing of service cooperation;

FIG. 16 is a flow chart showing an example of service cooperation processing;

FIG. 17 is a view showing the conceptual module configuration in a main configuration example of a second embodiment;

FIG. 18 is a flow chart showing an example of service processing;

FIG. 19 is a flow chart showing an example of individual service processing;

FIG. 20 is a flow chart showing an example of service processing;

FIG. 21 is a view showing the conceptual module configuration in a main configuration example of a third embodiment;

FIG. 22 is a flow chart showing an example of service processing;

FIG. 23 is a flow chart showing an example of service processing;

FIG. 24 is a flow chart showing a specific example of service processing;

FIG. 25 is a flow chart showing a specific example of service processing; and

FIG. 26 is a block diagram showing an example of the hardware configuration of a computer for realizing the present embodiment.

### DETAILED DESCRIPTION

Hereinafter, examples of various embodiments suitable for realizing the invention will be described with reference to the accompanying drawings.

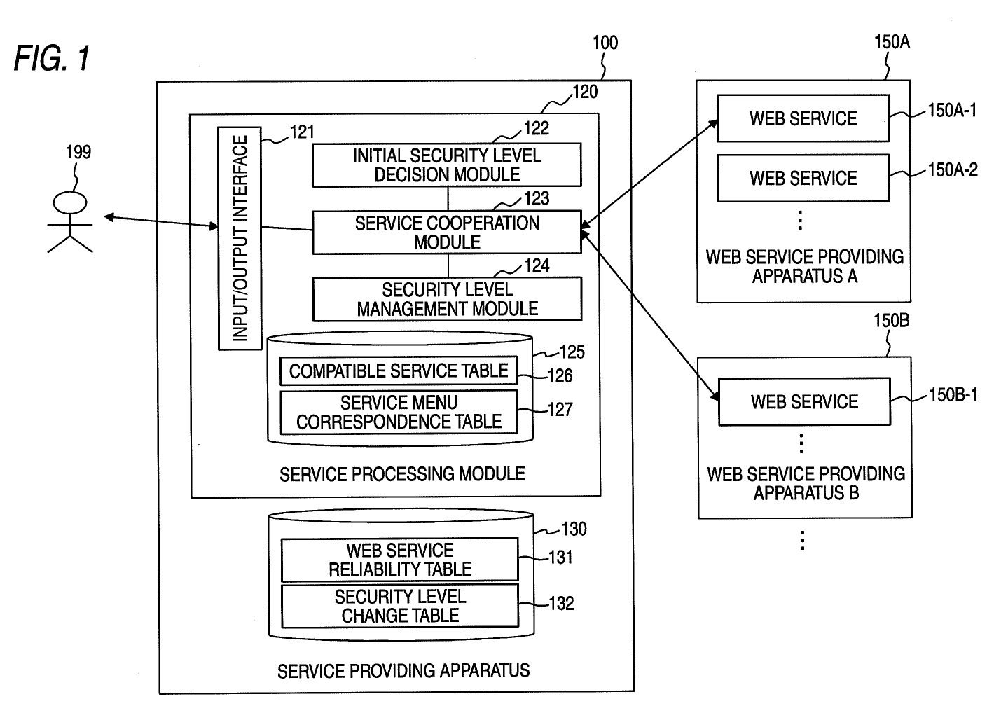

FIG. 1 is a view showing the conceptual module configuration in a typical configuration example of various kinds of embodiments.

In addition, modules generally refer to logically separable components, such as software (computer program) and hardware. Therefore, the module in the present embodiment indicates not only a module in a computer program but also a module in the hardware configuration. Thus, in the present embodiment, explanations of a computer program, a system, and a method are also made. In addition, “store”, “cause to be stored”, and words equivalent thereto are used for convenience of explanation, and these words mean being stored in a storage device or making a control to be stored in a storage device in the case when the embodiment is a computer program. In addition, a module corresponds to a function in a one-to-one manner. However, one module may be realized using one program or a plurality of modules may be realized using one program. Alternatively, one module may be realized using a plurality of programs. In addition, a plurality of modules may be executed by one computer, or one module may be executed by a plurality of computers in a distribution or parallel environment. In addition, other modules may be included in one module. In addition, “connection” referred to hereinafter is used not only for physical connection but also for logical connection (for example, the transmission and reception of data, instruction, and the reference relationship between data).

In addition, a system or an apparatus may be realized by connecting a plurality of computers, hardware, apparatuses, and the like to one another through a communication unit, such as a network (including communication connection of one-to-one correspondence), or may be realized using one computer, hardware, and an apparatus. “Apparatus” and “system” are used as synonymous terms. “Set beforehand” refers to being set before target processing and is used inclusively as meaning not only being set before processing of the present embodiment starts but also being set after processing of the present embodiment starts according to the situation and state at that time or the situation and state up to then as long as it is before target processing.

An information processing apparatus which is the present embodiment is an apparatus which makes a Web service providing apparatus A 150A or the like process a processing object in response to an operation of a user 199. As shown in the example of FIG. 1, the information processing apparatus includes a service providing apparatus 100, the Web service providing apparatus A 150A, and a Web service providing apparatus B 150B. The service providing apparatus 100 is connected to the Web service providing apparatus A 150A and the Web service providing apparatus B 150B by a communication line. Moreover, although two Web service providing apparatuses 150 are illustrated in FIG. 1, three or more Web service providing apparatuses may be present or one Web service providing apparatus may be present. In addition, in the present embodiment, a processing subject means a calculator, a program, or the like which processes a processing object. In the example shown in FIG. 1, a Web service 150A-1 and the like correspond to the processing subject. A plurality of processing subjects may perform processing (hereinafter, referred to as cooperative processing) in cooperation with each other. In addition, as a form of the cooperative processing, the processing may be performed sequentially or in parallel or may be performed by a combination thereof. Hereinafter, explanations will be performed using sequential processing as a main example.

The service providing apparatus 100 has a service processing module 120 and a reliability and security level association table storage module 130. Processing on a processing object is provided in response to an operation of the user 199. A service (processing) in which a plurality of Web services cooperate with each other is mainly provided.

The service processing module 120 has an input/output interface 121, an initial security level decision module 122, a service cooperation module 123, a security level management module 124, and a service association table storage module 125.

The input/output interface 121 is connected to the service cooperation module 123, and receives an operation of the user 199 and transmits the operation to the service cooperation module 123. In addition, an output from the service cooperation module 123 is performed through the input/output interface 121. For example, the input/output interface 121 includes hardware, such as a keyboard, a mouse, a display, and a touch panel, and controls these components. In addition, the input/output interface 121 is an interface provided by the HTTP protocol, for example, and the user 199 may control the input/output interface 121 via a communication line using a Web browser.

The initial security level decision module 122 is connected to the service cooperation module 123, and decides the reliability (hereinafter, referred to as a security level) required in order to process a processing object on the basis of the processing object. In addition, the initial security level decision module 122 transmits the decided reliability to the service cooperation module 123.

Here, the reliability required in order to process a processing object is an evaluation value regarding the security that a processing subject, which performs the processing, should have when processing the processing object. For a processing object, the requested reliability of the processing object is set beforehand. “Setting” herein means being set according to the processing security level decision flow which will be described, for example. In addition, for a processing subject, the reliability that the processing subject has is also set beforehand. “Setting” herein means being set by a Web service reliability table 600 which will be described later, for example.

For example, when the processing object is an image, the security level is set high if a text region or a face image is included by object recognition or the like. A more specific explanation will be made later with reference to FIGS. 12 to 14.

The service cooperation module 123 is connected to the input/output interface 121, the initial security level decision module 122, and the security level management module 124. When it is determined that processing is to be performed by the security level management module 124, the service cooperation module 123 requests a Web service, which is the processing subject, to process the processing object. More specifically, the service cooperation module 123 makes a Web service, which has a reliability higher than a reliability requested by a processing object, perform the processing, for example. In addition, the reliability decided by the initial security level decision module 122 is transmitted to the security level management module 124. In addition, an operation of the user 199 is received through the input/output interface 121, and the operation is transmitted to the security level management module 124 as necessary. As a result of the processing, a service menu and the like which are items are presented to a display of the input/output interface 121.

As request processing, specifically, a processing object and a processing parameter are transmitted to each Web service or received from each Web service in the order of cooperative processing according to the service cooperation information, for example. In addition, the service cooperation information is information required to perform cooperative processing and has at least the information, such as titles of Web services, the order, and required processing parameters.

The security level management module 124 is connected to the service cooperation module 123, and compares the reliability decided by the initial security level decision module 122 with the reliability of a processing subject in order to determine whether or not to make the processing subject process the processing object.

Moreover, when a plurality of processing subjects is required in order to perform the processing, the security level management module 124 may determine before performing the processing as to whether or not to make each of the processing subjects process the processing object.

Moreover, when a plurality of processing subjects is required in order to perform the processing, the security level management module 124 may determine whether or not to make the next processing subject process the processing object whenever processing by each of the plurality of processing subjects ends.

Moreover, when the security level management module 124 determines that there is no processing subject capable of processing the processing object, the security level management module 124 may determine whether or not to make another processing subject corresponding to the processing subject, which is stored in a compatible service table 126, process the processing object.

In addition, the security level management module 124 may determine whether or not to make a processing subject, which is stored in a service menu correspondence table 127 corresponding to an item selected on the basis of an operation of the user 199, process the processing object.

In addition, the security level management module 124 stores the reliability of a processing object, changes the reliability of a processing object according to the processing contents using a security level change table 132.

The service association table storage module 125 stores the compatible service table 126 and the service menu correspondence table 127.

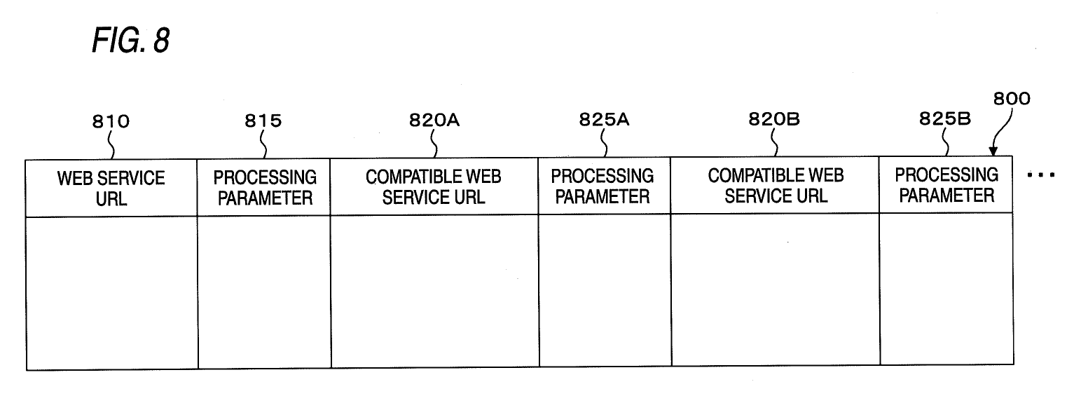

The compatible service table 126 stores a processing subject and another corresponding processing subject. For example, the compatible service table 126 stores a combination (a case of one processing subject is also included) of a processing subject and another processing subject, which is required to perform the same processing as that performed by the processing subject, so as to correspond to each other. Specifically, there is a compatible service table 800 illustrated in FIG. 8. FIG. 8 is an explanatory view showing an example of the data structure of the compatible service table 800. The compatible service table 800 has a Web service URL column 810, a processing parameter column 815, a compatible Web service URL column 820A, a processing parameter column 825A, a compatible Web service URL column 820B, a processing parameter column 825B, and the like. That is, the compatible service table 800 stores a set (when performing the same processing in cooperation, there is a plurality of sets of Web services and parameters) of a parameter and another Web service, which performs processing similar to (compatible with) processing performed on the basis of a set of a Web service and a parameter required when the Web service performs the processing, so as to correspond to each other.

The Web service URL column 810 stores a URL (Uniform Resource Locator) which provides a Web service.

The processing parameter column 815 stores a parameter required when the Web service performs processing.

The compatible Web service URL column 820A stores a URL of a Web service which performs the same processing as the Web service of the Web service URL column 810.

The processing parameter column 825A stores a parameter required when the Web service of the compatible Web service URL column 820A performs the processing.

The compatible Web service URL column 820B stores a URL which provides a second or subsequent Web service, when cooperative processing is required to perform the same processing as the Web service of the Web service URL column 810.

The processing parameter column 825B stores a parameter required when the Web service of the compatible Web service URL column 820B performs the processing. Then, sets of Web services and parameters required for cooperative processing continue.

Using a Web service as a key, the security level management module 124 or the like performs searching in the compatible service table 800 using a set of equal Web services as a value.

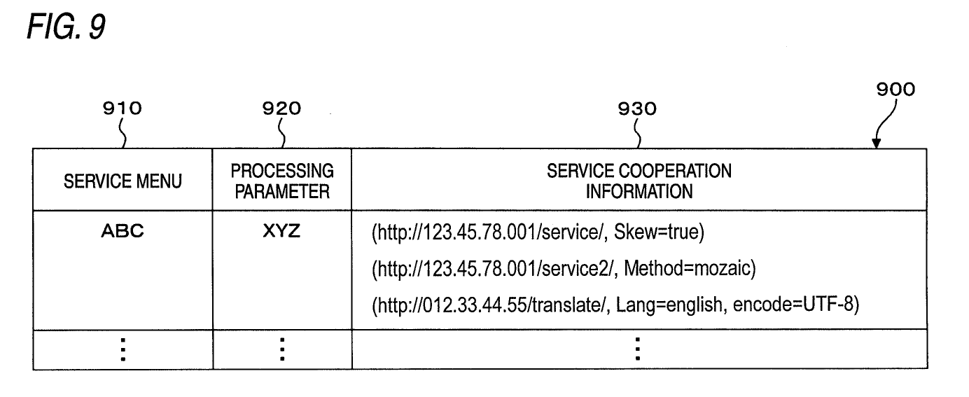

The service menu correspondence table 127 stores an item and a corresponding processing subject. For example, the service menu correspondence table 127 stores an item, which can be selected by the user 199, and a processing subject (may be one processing subject or may be a combination of a plurality of processing subjects which perform cooperative processing) corresponding to the item so as to correspond to each other. Specifically, there is a service menu correspondence table 900 illustrated in FIG. 9. FIG. 9 is an explanatory view showing an example of the data structure of the service menu correspondence table 900. The service menu correspondence table 900 has a service menu column 910, a processing parameter column 920, and a service cooperation information column 930. That is, the service menu correspondence table 900 stores the information required to instruct processing for the user 199.

The service menu column 910 stores a title (item) of a service menu that the input/output interface 121 presents to a display or the like for the user 199.

The processing parameter column 920 stores a parameter required when providing the service.

The service cooperation information column 930 stores a Web service group (may be one) for providing the service. The service cooperation information column 930 is configured to have a set of a URL which provides a Web service and a parameter required for the processing. In the case of cooperative processing, the service cooperation information column 930 stores the set in order of processing.

Using a service menu as a key, the security level management module 124 or the like performs searching in the service menu correspondence table 900 using a set of Web services, which provide the service, as a value. Since the service providing apparatus 100 is used for the user 199 which is an end user, the service providing apparatus 100 is optionally prepared. However, the service menu correspondence table 900 may not be provided.

The reliability and security level association table storage module 130 records a Web service reliability table 131 and a security level change table 132.

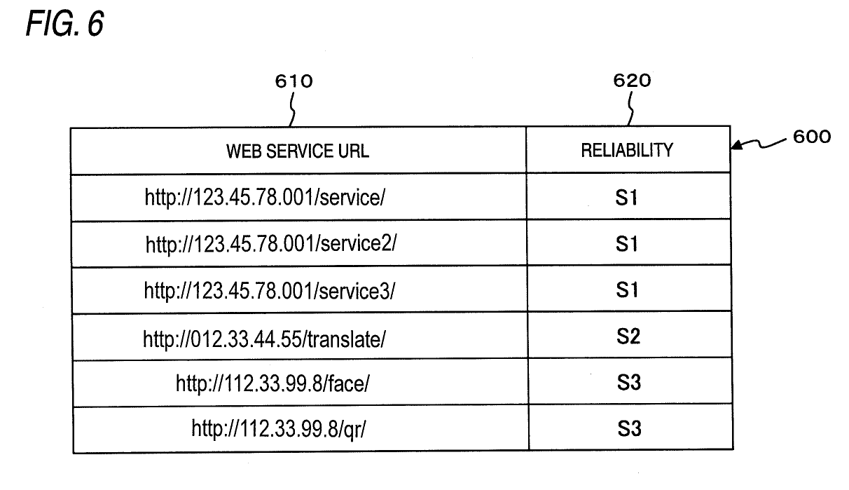

The Web service reliability table 131 is a correspondence table of a processing subject and reliability. Specifically, there is a Web service reliability table 600 illustrated in FIG. 6. FIG. 6 is an explanatory view showing an example of the data structure of the Web service reliability table 600. The Web service reliability table 600 has a Web service URL column 610 and a reliability column 620. That is, the Web service reliability table 600 shows the correspondence between a URL of a Web service and the reliability, which indicates that the processing is permitted when the reliability of a processing object is equal to or lower than a predetermined level.

The Web service URL column 610 stores a URL which provides a Web service.

The reliability column 620 stores the reliability of the Web service.

Using a Web service as a key, the security level management module 124 or the like performs searching in the Web service reliability table 600 using the reliability, which can be processed by the Web service, as a value.

Here, in the case of a small value (number which follows a character “S”) of reliability, a higher security level is needed than in the case of a large value of reliability. For example, in the case of a service with reliability S1, the security level of a processing object needs to be higher than that in the case of a service with reliability S3. For example, the case where the reliability of a Web service is lower than the security level of a processing object is a case where the reliability of the Web service is insufficient, which means that the Web service cannot perform the processing of the processing object. In addition, adding a positive value as a degree of change in the security level means increasing the security level. For example, adding the degree of change of 1 to the reliability S3 means that the reliability becomes S2. To the contrary, adding a negative value as a degree of change in the security level means decreasing the security level. For example, adding the degree of change of −1 to the reliability S3 means that the reliability becomes S4.

In addition, an operator sets the reliability of each Web service beforehand based on a standard, such as whether or not the Web service is an in-company service, whether or not the Web service is a de-facto standard service, and whether or not information security measures are performed.

In addition, a URL of a Web service may be provided for every Web service or may be provided for every domain assuming that the reliability of Web services belonging to a domain is equal.

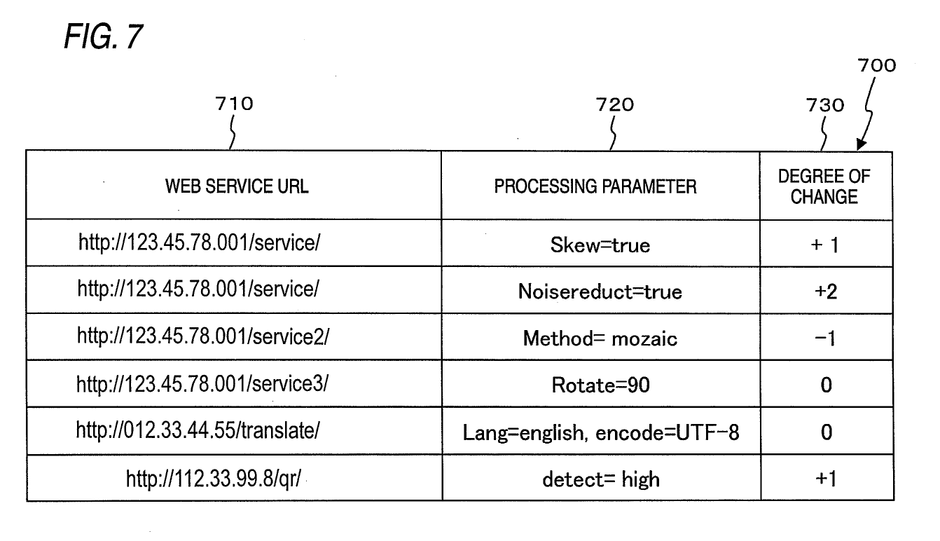

The security level change table 132 is a table which describes how to change the reliability that the processing object requires by performing which kind of processing. Specifically, there is a security level change table 700 illustrated in FIG. 7. FIG. 7 is an explanatory view showing an example of the data structure of the security level change table 700. The security level change table 700 has a Web service URL column 710, a processing parameter column 720, and a change degree column 730. That is, the combination of a URL of a Web service and a given processing parameter is the processing contents, and it is shown how the security level of a processing object changes with a degree of change in the security level based on each processing content, that is, by processing.

The Web service URL column 710 stores a URL of a Web service.

The processing parameter column 720 stores a parameter given to the Web service of the Web service URL column 710.

The change degree column 730 stores a value for changing the security level of a processing object when the Web service of the Web service URL column 710 performs processing with a parameter of the processing parameter column 720. For example, when the processing object is an image, the change of reliability is set from the point of view of whether or not extraction of metadata or recognition of an image object becomes easy.

The Web service providing apparatus 150 has Web services 150A-1, 150A-2, and the like. For example, the Web service providing apparatus 150 is a program for performing a service in which actual processing provided by SOAP (Simple Object Access Protocol), REST (Representational State Transfer), or the like is performed.

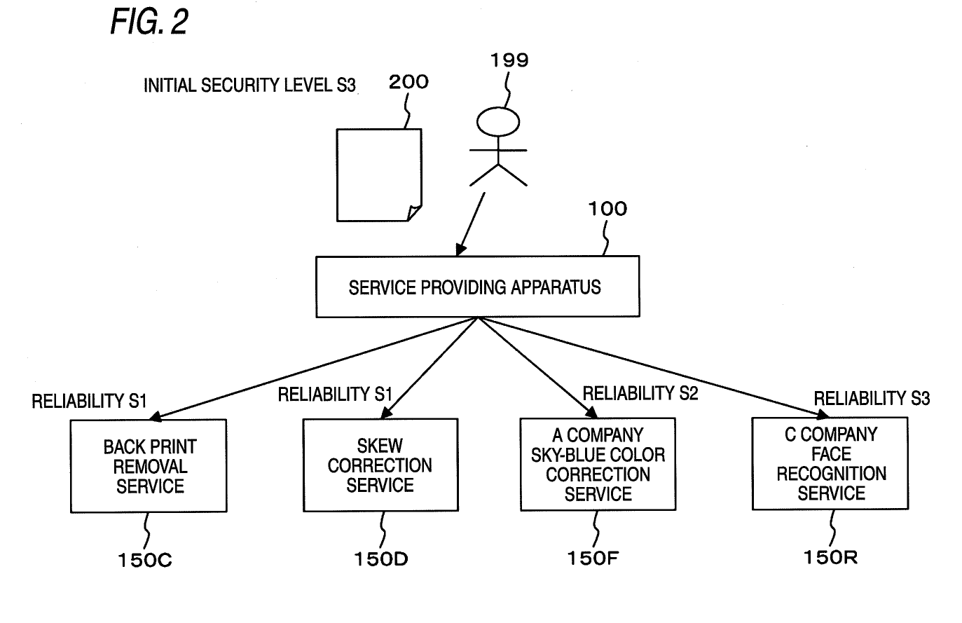

Next, an example of service processing when the present embodiment is embodied will be described with reference to FIGS. 2 to 5.

The user 199 requests the service providing apparatus 100 to process a service in which a plurality of services cooperates with each other. The initial security level of a document 200 to be processed is determined at the start of processing. In addition, the “security level” described in the following explanation/processing flow is given to a processing object and the “reliability” is given to a service, and the description will be made mainly separately.

The service providing apparatus 100 can perform the processing using a back print removal service 150C with the reliability S1, a skew correction service 150D with the reliability S1, an A company sky-blue color correction service 150F with the reliability S2, and a C company face recognition service 150R with the reliability S3. In addition, since the back print removal service 150C and the skew correction service 150D are provided by its own company, the reliability is set high. However, since the A company sky-blue color correction service 150F and the C company face recognition service 150R are provided by other companies, the reliability is set low. In addition, the reliability of these Web services is set by the Web service reliability table 131.

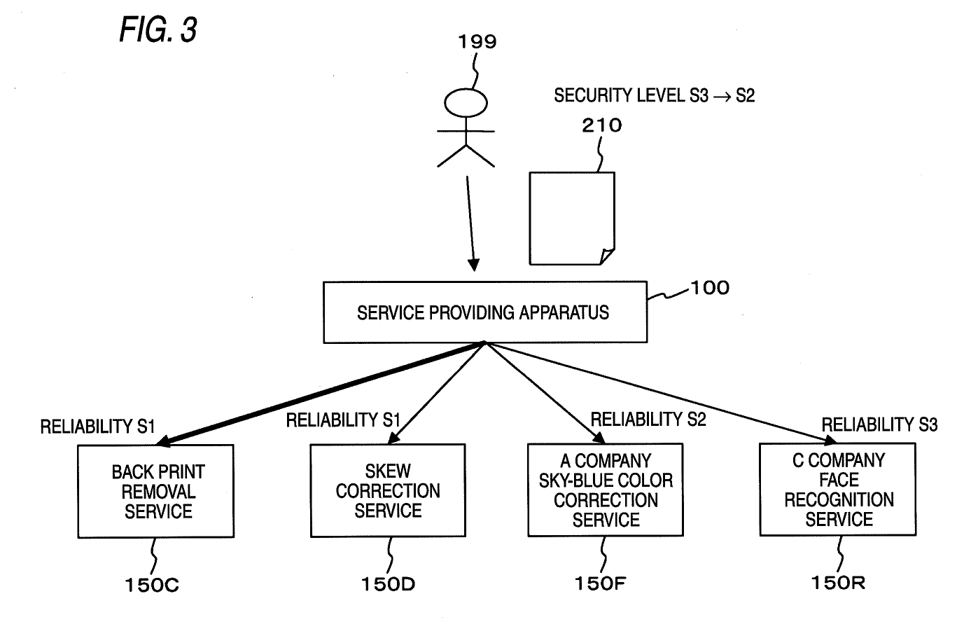

FIG. 3 shows that since extraction of metadata or recognition of an image object in the document 200 becomes easy as a result of processing using the back print removal service 150C, the security level of a document 210 which is a result of the processing is increased. This is performed using the security level change table 132 by the security level management module 124.

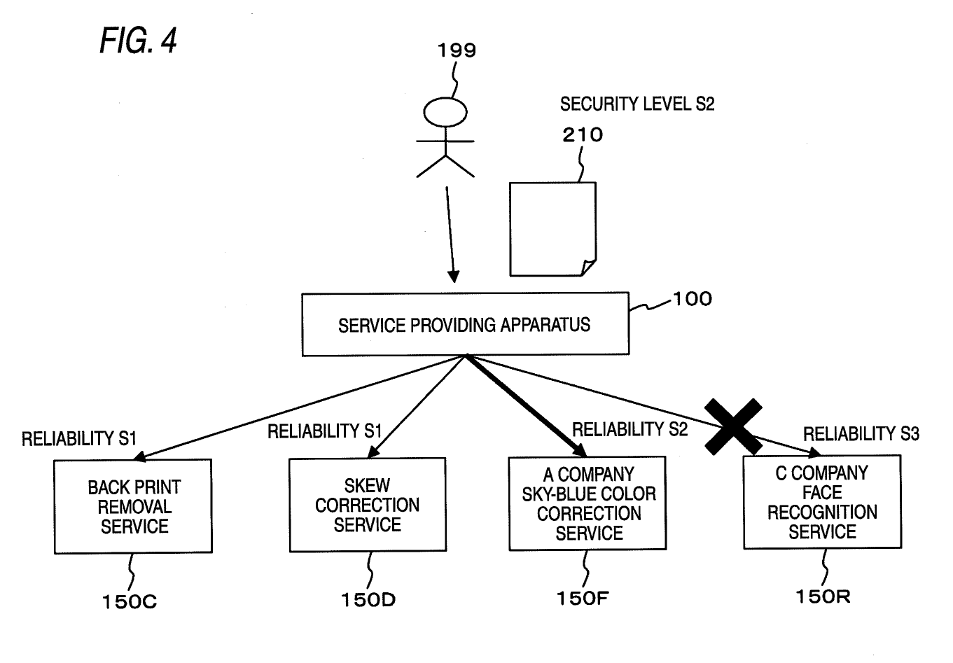

FIG. 4 shows that the document 210 whose security level has changed from S3 to S2 can use the back print removal service 150C with the reliability S1, the skew correction service 150D with the reliability S1, and the A company sky-blue color correction service 150F with the reliability S2, but cannot use the C company facial recognition service 150R with the reliability S3 since the C company facial recognition service 150R has a problem in security. For this processing, the security level management module 124 makes a determination by comparing the security level of the document 210 with the reliability of a Web service.

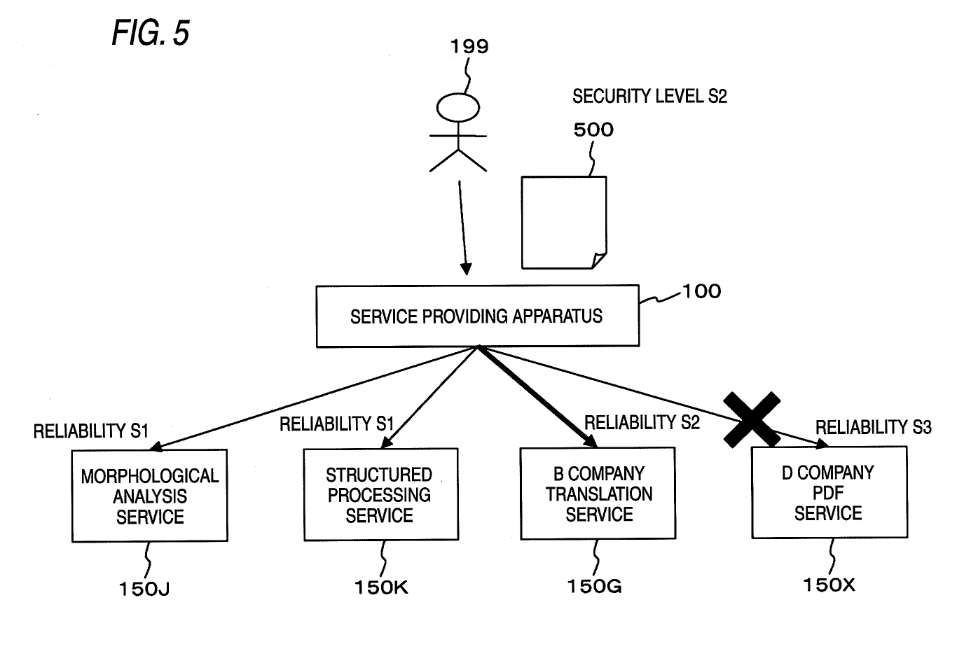

Although the examples in FIGS. 2 to 4 showed examples of an image as a processing object, FIG. 5 shows an example of text data as a processing object. The security level of a document 500 to be processed is evaluated from the point of view that the document 500 is automatically processed since the document 500 is text data. The security level of S2 which is higher than the reliability S3 of a D company PDF service 150X is set for the document 500. Accordingly, processing using the D company PDF service 150X cannot be performed.

In addition, a structured XML (eXtensible Markup Language) document or the like is managed by giving a higher security level thereto than that given to the document 500 which is the text data of a natural language.

### First Embodiment

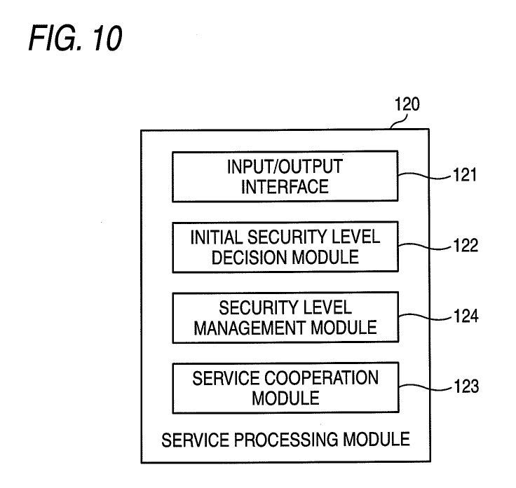

FIG. 10 is a view showing the conceptual module configuration in a main configuration example of a first embodiment. The service processing module 120 in the first embodiment has the input/output interface 121, the initial security level decision module 122, the service cooperation module 123, and the security level management module 124.

The service cooperation information (sequence of Web services used, parameters designated for combination and each Web service) is designated from those other than the service providing apparatus 100 (that is, a service menu is not used), and processing continues after error or skipping processing when a Web service with reliability which does not satisfy the security level is included. That is, a compatible Web service is not used, but error processing or the like is performed.

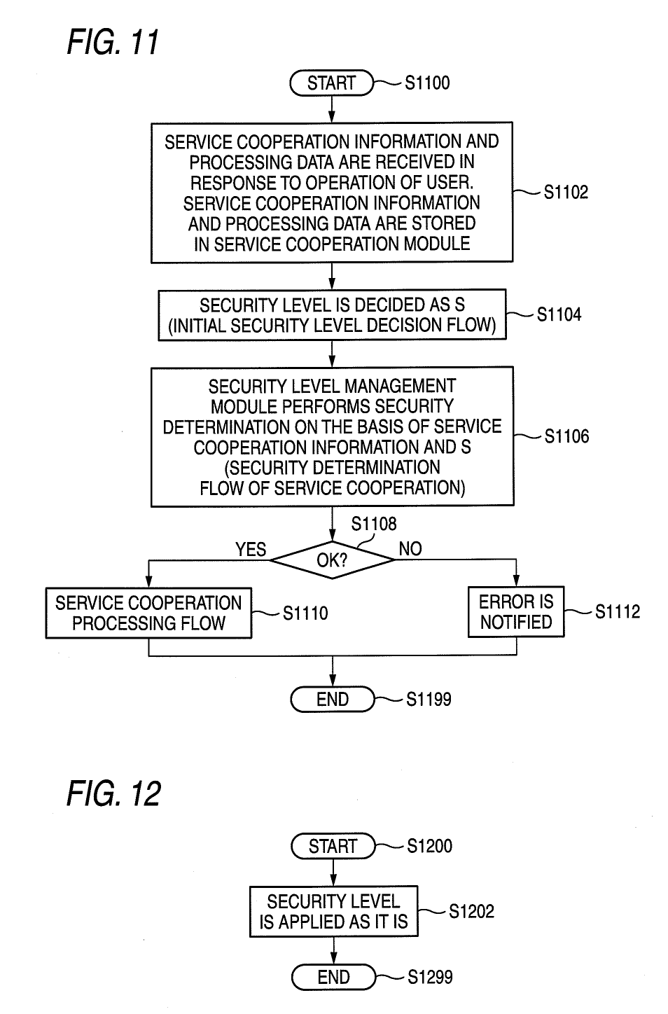

FIG. 11 is a flow chart showing an example of service processing in the first embodiment. It is determined whether or not a Web service with reliability which does not satisfy the security level is mixed using the information before processing.

In step S1102, the service cooperation module 123 receives the service cooperation information and a processing object (hereinafter, a processing object is referred to as processing data) in response to an operation of a user. The service cooperation information and the processing data are stored in the service cooperation module 123.

In step S1104, the initial security level decision module 122 decides the security level as S. Any one of the initial security level decision flows illustrated in FIGS. 12 to 14 is used. This will be described later.

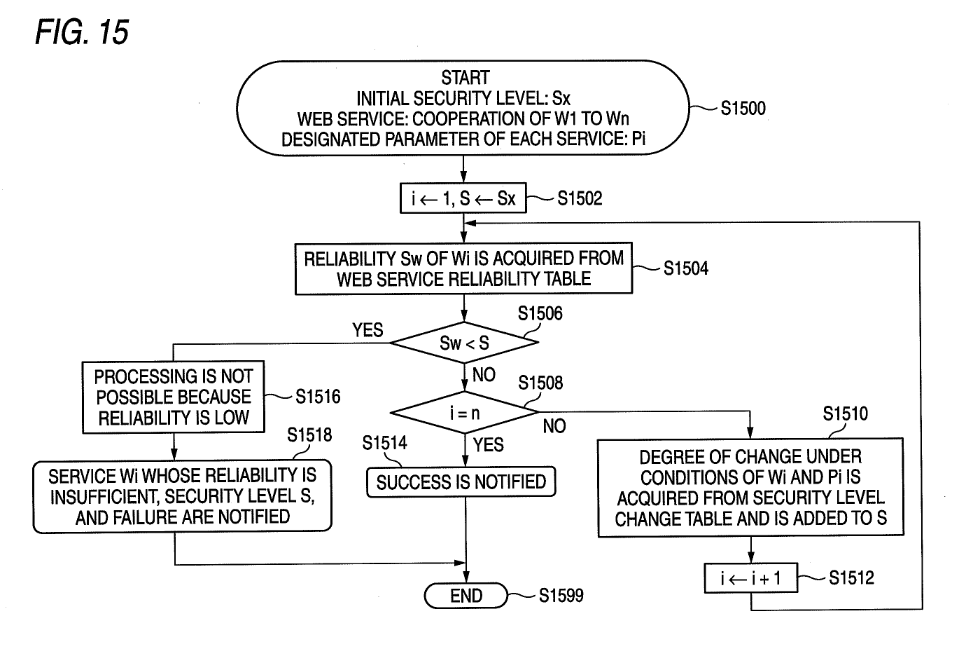

In step S1106, the security level management module 124 performs security determination based on the service cooperation information and S. The security determination is performed according to a security determination flow of service cooperation illustrated in FIG. 15 which will be described later.

In step S1108, it is determined whether or not a result of the determination in step S1106 is O.K. When the determination result is O.K. (when the processing is performed only by a Web service which satisfies the security level of processing data), the process proceeds to step S1110. In other cases (when a Web service which does not satisfy the security level of processing data is included), the process proceeds to step S1112.

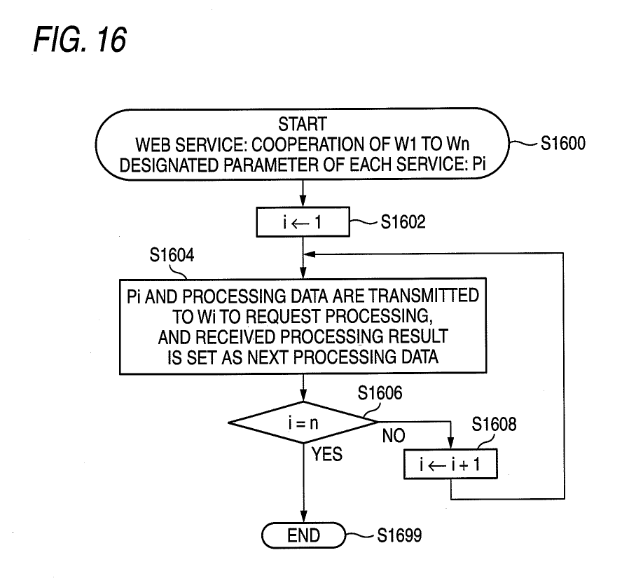

In step S1110, a service cooperation processing flow illustrated in FIG. 16, which will be described later, is executed. Then, the process ends (step S1199).

In step S1112, the input/output interface 121 performs error notification (displays an error message on a display). Then, the process ends (step S1199).

The flow charts illustrated in FIG. 12 to FIG. 14 correspond to the processing in step S1104 in the flow chart illustrated in FIG. 11. The initial security level decision module 122 performs the processing shown in the flow charts, and the security level management module 124 stores the security level decided in the end.

FIG. 12 is a flow chart showing a first decision processing example of a new security level. This is processing when the security level is given to the processing data. That is, this is a case where the security level is included as an attribute or the like in the processing data.

In step S1202, the initial security level decision module 122 extracts the security level given to the processing data and applies the security level as it is.

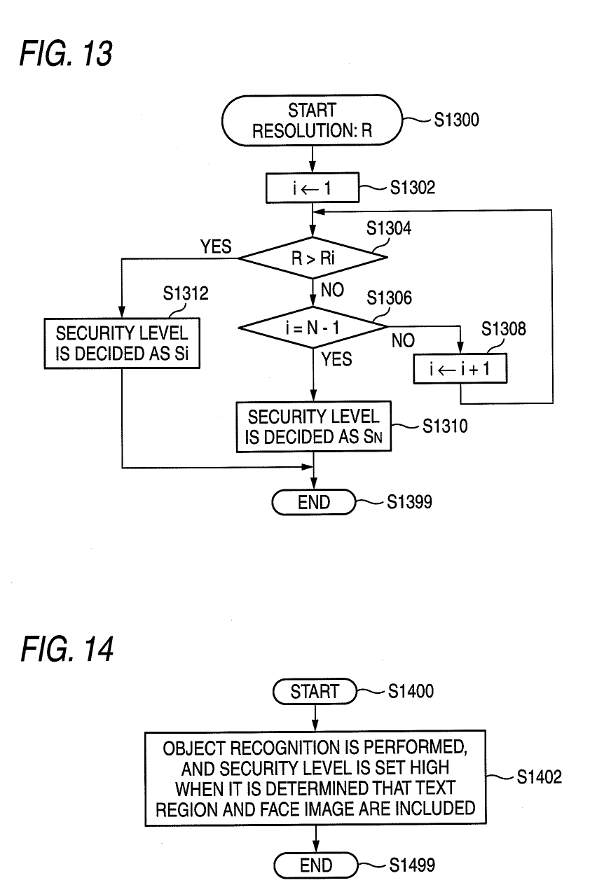

FIG. 13 is a flow chart showing a second decision processing example of the new security level. This is processing when the processing data is an image.

In step S1300, the resolution of the processing data is extracted and set to R. In addition, the threshold value of the resolution assigned to each security level in the N-step security level Si (i: 1 to N) is set to Ri (i: 1 to N−1). The relationship between Ri and Si is set such that the security level increases as the resolution increases.

In step S1302, 1 is substituted into a variable i.

In step S1304, it is determined whether or not R>Ri is satisfied. In the case of R>Ri, the process proceeds to step S1312. In other cases, the process proceeds to step S1306.

In step S1306, it is determined whether or not the variable i is equal to N−1. When the variable i is equal to N−1, the process proceeds to step S1310. In other cases, the process proceeds to step S1308.

In step S1308, i+1 is substituted into the variable i. Then, the process returns to step S1304.

In step S1310, the security level of processing data is decided as SN. Then, the process ends (step S1399).

In step S1312, the security level of processing data is decided as Si. Then, the process ends (step S1399).

FIG. 14 is a flow chart showing a third decision processing example of the new security level. This is processing when the processing data is an image.

In step S1402, object recognition is performed on an image (types (text region, graphic region, photograph region, and the like) of objects included in the image are recognized). When it is determined that a text region and a face image are included, the security level is set high.

FIG. 15 is a flow chart showing an example of security determination processing of service cooperation. This is the processing in step S1106 in the flow chart illustrated in FIG. 11. The security level management module 124 performs the processing shown in the flow chart to determine whether or not there is a Web service with reliability, which does not satisfy the security level, from the prior information before performing the processing.

In step S1500, it is assumed that the initial security level is Sx, a Web service is performed by cooperation of W1 to Wn, and a designated parameter of each service is Pi.

In step S1502, 1 is substituted into the variable i and Sx is substituted into a variable S.

In step S1504, the reliability Sw of Wi is acquired using the Web service reliability table 131.

In step S1506, it is determined whether or not Sw<S is satisfied. That is, the reliability of a Web service is compared with the security level of processing data.

In the case of Sw<S (when the reliability of a Web service satisfies the security level of processing data, for example, in the case of Sw=S3 and S=S2), the process proceeds to step S1516. In other cases (when the reliability of a Web service does not satisfy the security level of processing data), the process proceeds to step S1508.

In step S1508, it is determined whether or not the variable i is equal to n. When the variable i is equal to n, the process proceeds to step S1514. In other cases, the process proceeds to step S1510. That is, it is determined whether or not determination processing has been performed until a final Web service of the cooperative processing.

In step S1510, the degree of change when the processing in (Wi, Pi) has been performed using the security level change table 132 is acquired, and the degree of change is added to S.

In step S1512, i+1 is substituted into the variable i. Then, the process returns to step S1504.

In step S1514, a success is notified. Then, the process ends (step S1599). That is, the process returns to the original processing flow (step S1106 and the like in the flow chart illustrated in FIG. 11), and a determination (step S1108 and the like in the flow chart illustrated in FIG. 11) using the contents of the notice is performed.

In step S1516, it is assumed that the processing is not possible because the reliability is low (reliability of a Web service does not satisfy the security level of processing data).

In step S1518, the service Wi whose reliability is insufficient, the security level S, and failure are notified. Then, the process ends (step S1599). That is, the process returns to the original processing flow (step S1106 and the like in the flow chart illustrated in FIG. 11), and a determination (step S1108 and the like in the flow chart illustrated in FIG. 11) using the contents of the notice is performed.

FIG. 16 is a flow chart showing an example of service cooperation processing. This is the processing in step S1110 in the flow chart illustrated in FIG. 11. The service cooperation module 123 performs the processing shown in the flow chart. This processing is performed when processing of a Web service is permitted by prior determination, for example, when the reliability of a Web service is higher than the security level of processing data.

In step S1600, it is assumed that a Web service is performed by cooperation of W1 to Wn and a designated parameter of each service is Pi.

In step S1602, 1 is substituted into the variable i.

In step S1604, Pi and the processing data are transmitted to the corresponding Web service Wi to request the processing, and the received processing result is set as next processing data.

In step S1606, it is determined whether or not the variable i is equal to n. When the variable i is equal to n, the process ends (step S1699). In other cases, the process proceeds to step S1608.

In step S1608, i+1 is substituted into the variable i. Then, the process returns to step S1604.

### Second Embodiment

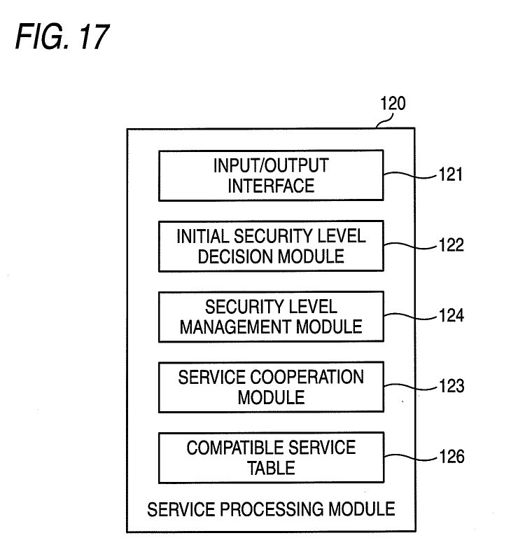

FIG. 17 is a view showing the conceptual module configuration in a main configuration example of a second embodiment. A service processing module 120 in the second embodiment has an input/output interface 121, an initial security level decision module 122, a service cooperation module 123, a security level management module 124, and a compatible service table 126.

The service cooperation information is designated from those other than the service providing apparatus 100. When a Web service with reliability which does not satisfy the security level is included, the processing is performed by selecting a set of equal Web services which satisfy the security level using the compatible service table 126.

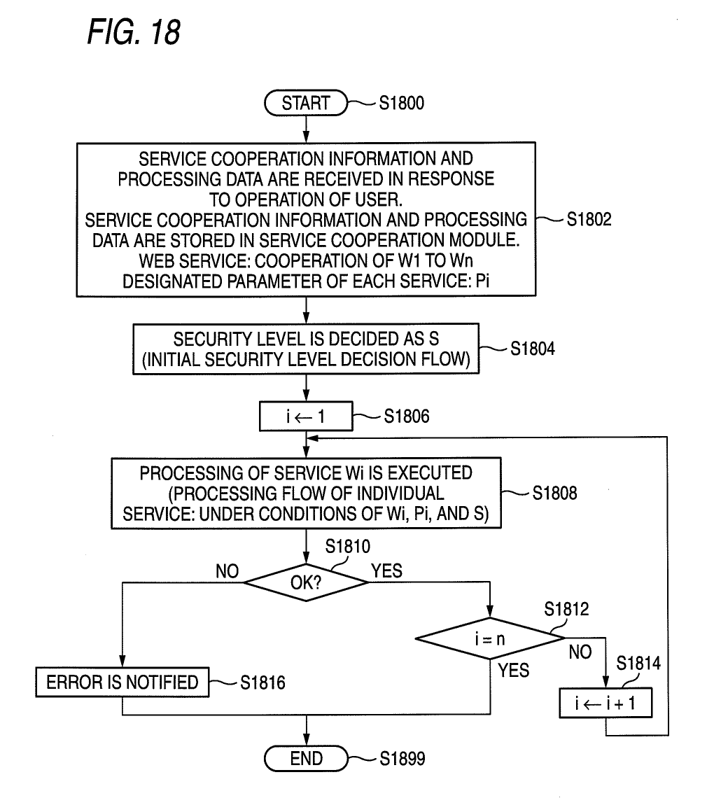

FIG. 18 is a flow chart showing a first service processing example in the second embodiment. This is a processing flow in which the service cooperation information is designated from those other than the service providing apparatus 100 and a determination on whether or not a Web service with reliability, which does not satisfy the security level of processing data, is included is performed while performing actual processing.

In step S1802, the service cooperation module 123 receives the service cooperation information and the processing data in response to an operation of a user. The service cooperation information and the processing data are stored in the service cooperation module 123. A Web service is assumed to be performed by cooperation of W1 to Wn, and a designated parameter of each Web service is set to Pi.

In step S1804, the initial security level decision module 122 decides the security level as S. Any one of the initial security level decision flows illustrated in FIGS. 12 to 14 is used.

In step S1806, the security level management module 124 substitutes 1 into the variable i.

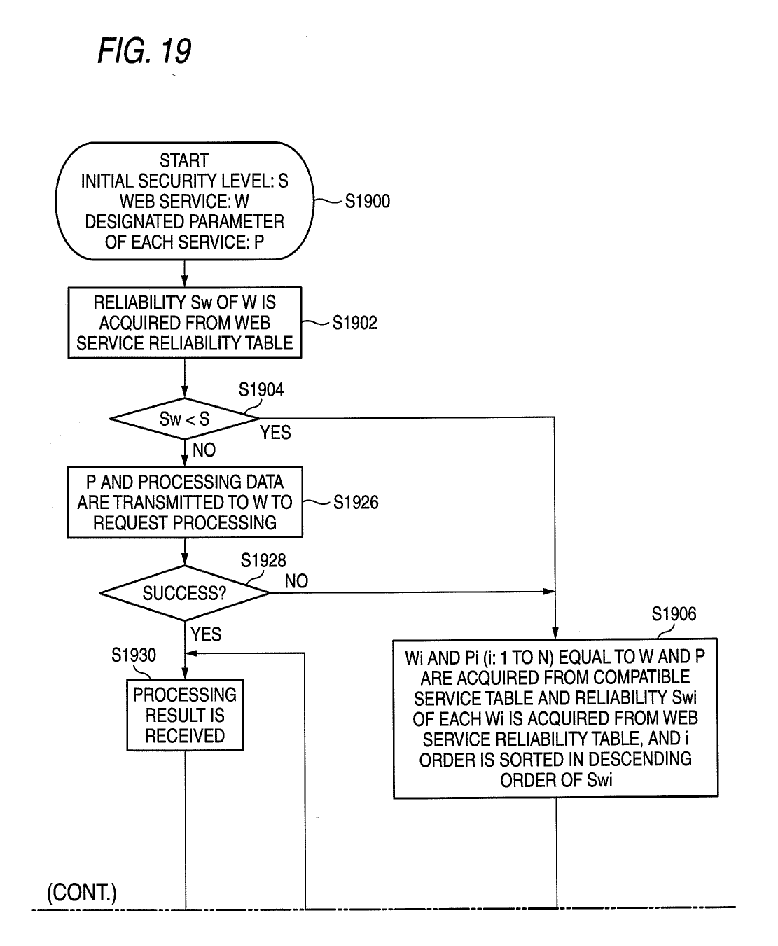

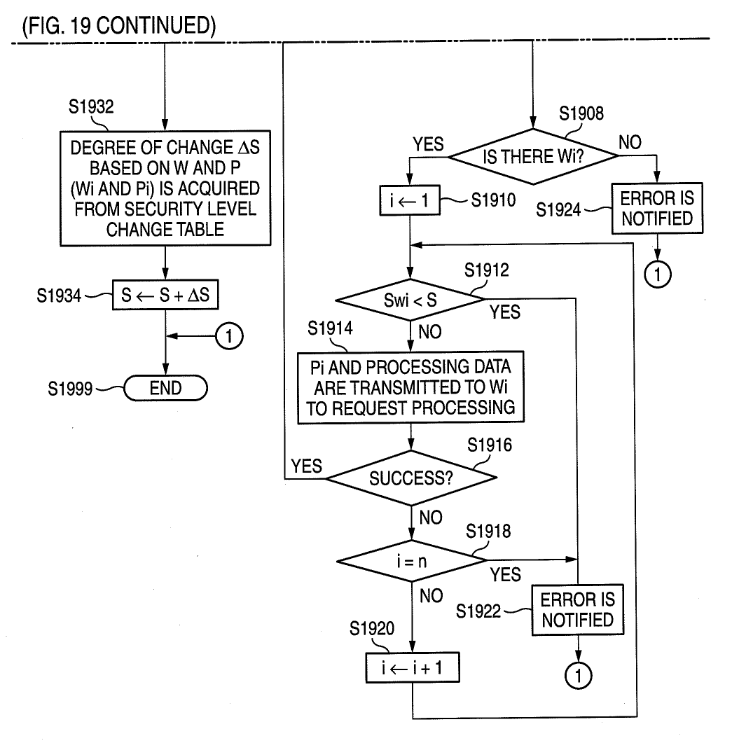

In step S1808, the service cooperation module 123 executes processing of the Web service Wi. The processing flow of an individual service illustrated in FIG. 19 is used under conditions of Wi, Pi, and S. This will be described later.

In step S1810, the security level management module 124 determines whether or not a result of the determination in step S1808 is O.K. When the determination result is O.K. (when a Web service is performed), the process proceeds to step S1812. In other cases, the process proceeds to step S1816.

In step S1812, the security level management module 124 determines whether or not the variable i is equal to n. When the variable i is equal to n, the process ends (step S1899). In other cases, the process proceeds to step S1814.

In step S1814, the security level management module 124 substitutes i+1 into the variable i. Then, the process returns to step S1808.

In step S1816, the input/output interface 121 performs error notification. Then, the process ends (step S1899).

FIG. 19 is a flow chart showing an individual service processing example. This is the processing in step S1808 in the flow chart illustrated in FIG. 18. The service cooperation module 123 mainly performs the processing shown in the flow chart to determine whether or not a Web service with reliability, which does not satisfy the security level, is included while actually performing the processing.

In step S1900, the initial security level is set to S, a Web service is set to W, and a designated parameter of the service is set to P.

In step S1902, the reliability Sw of W is acquired using the Web service reliability table 131.

In step S1904, it is determined whether or not Sw<S is satisfied. In the case of Sw<S, the process proceeds to step S1906. In other cases, the process proceeds to step S1926.

In step S1906, Wi and Pi (i: 1 to n) equal to W and P are acquired using the compatible service table 126 and the reliability Swi of each Wi is acquired using the Web service reliability table 131, and the i order is sorted in descending order of Swi, that is, in order from a service with high reliability to a service with low reliability. That is, for a compatible Web service, processing is performed in a range of the reliability of the Web service where the security level of processing data is permitted.

In step S1908, it is determined whether or not there is Wi. When there is Wi, the process proceeds to step S1910. In other cases (when there is no compatible Web service), the process proceeds to step S1924.

In step S1910, 1 is substituted into the variable i.

In step S1912, it is determined whether or not Swi<S is satisfied. In the case of Swi<S (when the reliability is low (when the reliability of the Web service does not satisfy the security level of processing data)), the process proceeds to step S1922. In other cases, the process proceeds to step S1914.

In step S1914, Pi and the processing data are transmitted to Wi to request the processing.

In step S1916, it is determined whether or not the processing in step S1914 was successful. When the processing in step S1914 was successful, the process proceeds to step S1930. In other cases, the process proceeds to step S1918.

In step S1918, it is determined whether or not the variable i is equal to n. When the variable i is equal to n, the process proceeds to step S1922. In other cases, the process proceeds to step S1920.

In step S1920, i+1 is substituted into the variable i. Then, the process returns to step S1912.

In step S1922, the input/output interface 121 performs error notification. Then, the process ends (step S1999).

In step S1924, the input/output interface 121 performs error notification. Then, the process ends (step S1999).

In step S1926, P and the processing data are transmitted to W to request the processing.

In step S1928, it is determined whether or not the processing in step S1926 was successful. When the processing in step S1926 was successful, the process proceeds to step S1930. In other cases, the process proceeds to step S1906.

In step S1930, a result of the processing in step S1926 is received.

In step S1932, a degree of change ΔS based on W and P (Wi and Pi) is acquired using the security level change table 132.

In step S1934, S+ΔS is substituted into the variable S. Then, the process ends (step S1999).

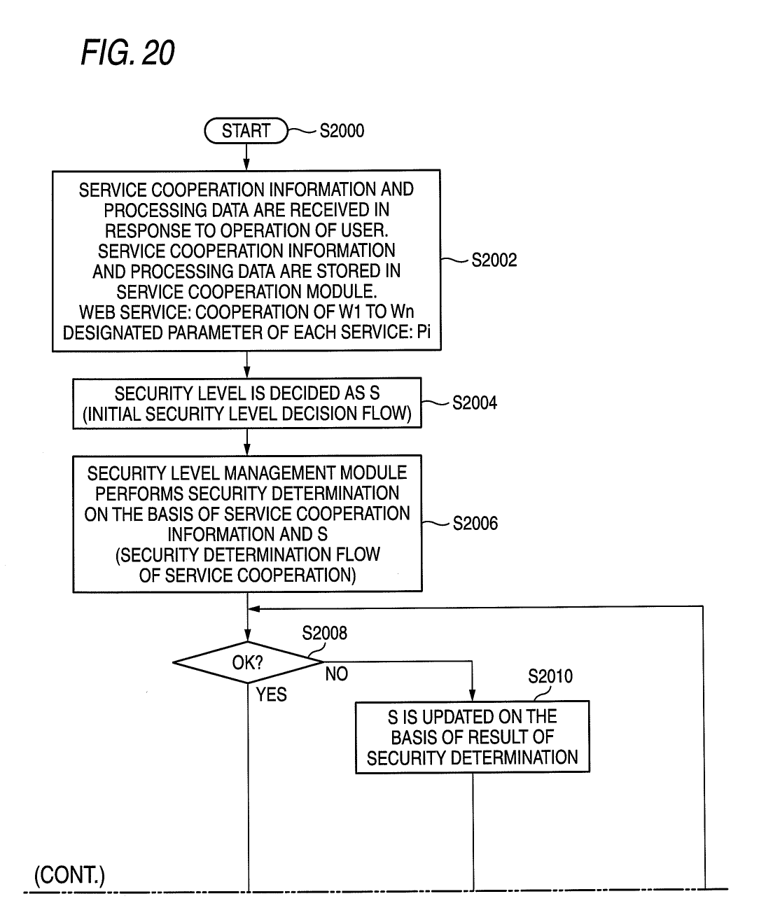

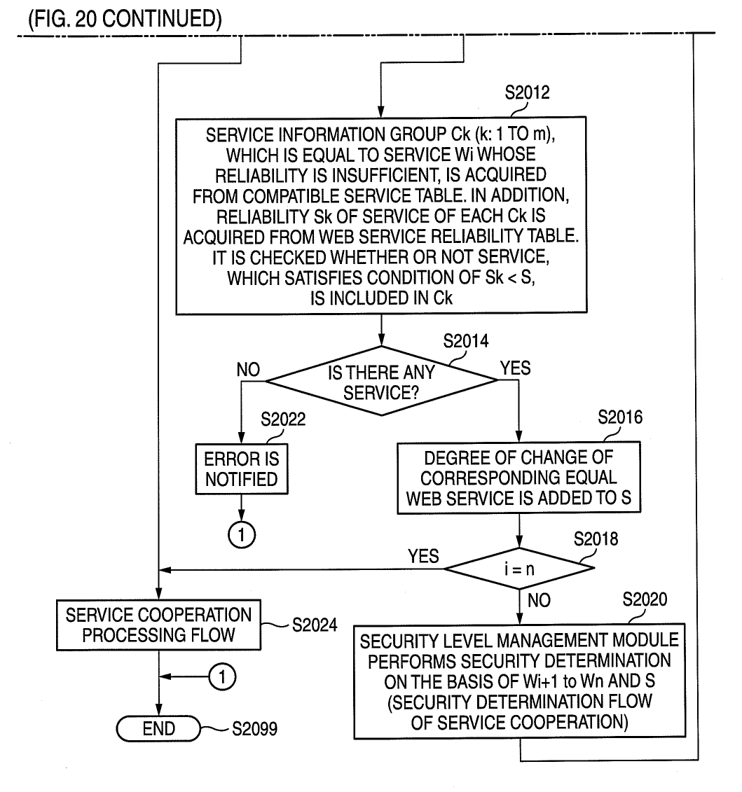

FIG. 20 is a flow chart showing a second service processing example in the second embodiment. This is a processing flow in which the service cooperation information is designated from those other than the service providing apparatus 100 and a determination is performed before performing actual processing while changing a Web service using the compatible service table 126 when a Web service with reliability, which does not satisfy the security level, is included.

In step S2002, the service cooperation module 123 receives the service cooperation information and the processing data in response to an operation of a user.

The service cooperation information and the processing data are stored in the service cooperation module 123. A Web service is assumed to be performed by cooperation of W1 to Wn, and a designated parameter of each Web service is set to Pi.

In step S2004, the initial security level decision module 122 decides the security level as S. Any one of the initial security level decision flows illustrated in FIGS. 12 to 14 is used.

In step S2006, the security level management module 124 performs security determination based on the service cooperation information and S. The security determination is performed according to the security determination flow of service cooperation illustrated in FIG. 15.

In step S2008, the security level management module 124 determines whether or not a result of the determination in step S2006 is O.K. When the determination result is O.K., the process proceeds to step S2024. In other cases, the process proceeds to step S2010.

In step S2010, the security level management module 124 updates S based on the result of security determination (step S2006 or step S2020).

In step S2012, the security level management module 124 acquires a service information group Ck (k: 1 to m), which is equal to the service Wi whose reliability is insufficient (that is, the reliability of the Web service does not satisfy the security level of processing data), using the compatible service table 126. In addition, the reliability Sk of a service of each service information group Ck is acquired using the Web service reliability table 131. It is checked whether or not a service, which satisfies the condition of Sk<S, is included in Ck.

In step S2014, the security level management module 124 determines whether or not there is any service of the processing result in step S2012. When there is a service of the processing result in step S2012, the process proceeds to step S2016. In other cases, the process proceeds to step S2022.

In step S2016, the security level management module 124 adds to S the degree of change of the corresponding equal Web service.

In step S2018, the security level management module 124 determines whether or not the variable i is equal to n. When the variable i is equal to n, the process proceeds to step S2024. In other cases, the process proceeds to step S2020.

In step S2020, the security level management module 124 performs security determination using Wi+1 to Wn and S. The security determination is performed according to the security determination flow of service cooperation illustrated in FIG. 15. Then, the process returns to step S2008.

In step S2022, the input/output interface 121 performs error notification. Then, the process ends (step S2099).

In step S2024, the service cooperation module 123 executes the service cooperation processing flow illustrated in FIG. 16. Then, the process ends (step S2099).

### Third Embodiment

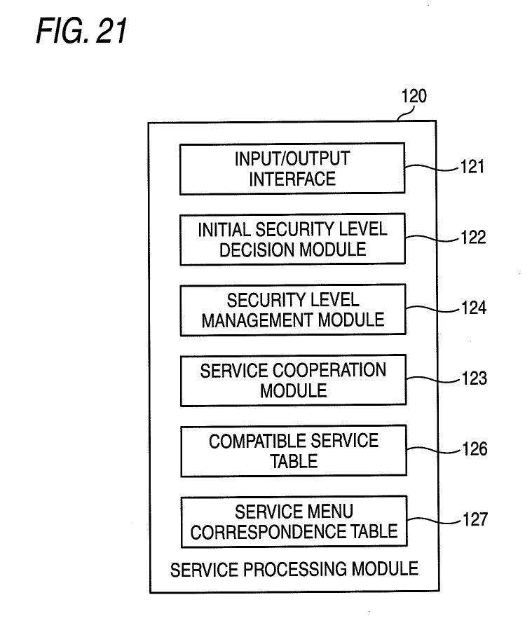

FIG. 21 is a view showing the conceptual module configuration in a main configuration example of a third embodiment. A service processing module 120 in the third embodiment has an input/output interface 121, an initial security level decision module 122, a service cooperation module 123, a security level management module 124, a compatible service table 126, and a service menu correspondence table 127.

When one item in a service menu is selected by an operation of a user, the processing is performed by designating a processing parameter and acquiring the combination of Web services which satisfy the security level of processing data using the service menu correspondence table 127.

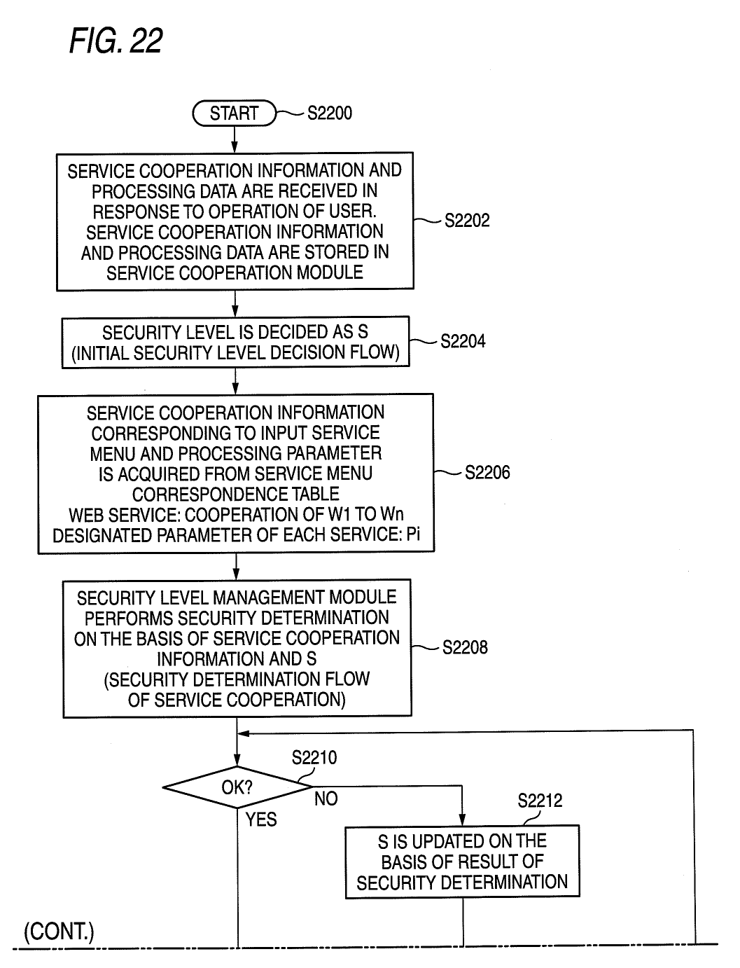

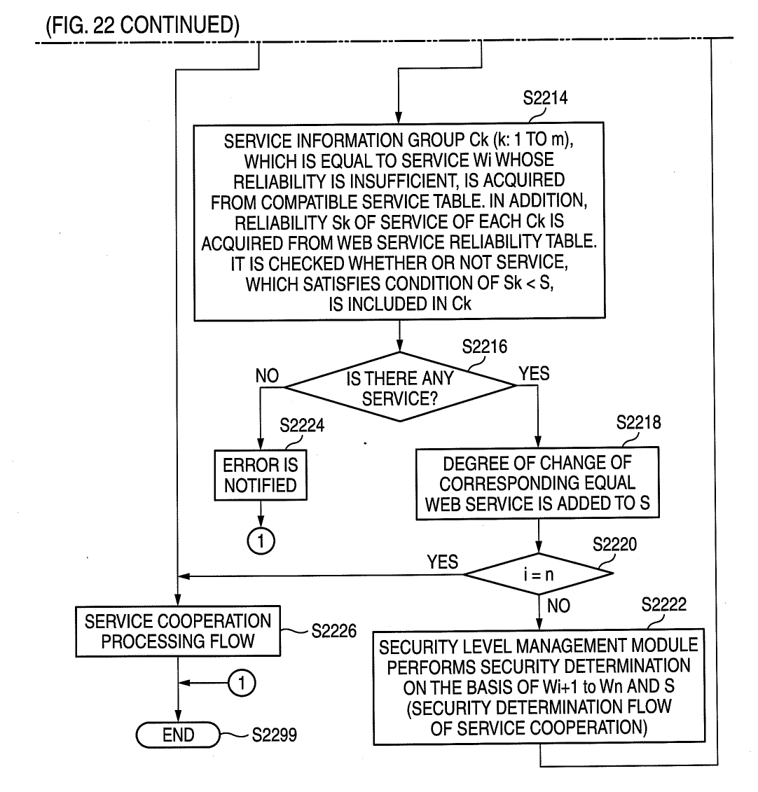

FIG. 22 is a flow chart showing a first service processing example in the third embodiment. This is a processing flow in which designation is performed using a service menu and a determination is performed before performing actual processing while changing a Web service using the compatible service table 126 when a Web service with reliability, which does not satisfy the security level of processing data, is included.

In step S2202, the service cooperation module 123 receives the service cooperation information and the processing data in response to an operation of a user. The service cooperation information and the processing data are stored in the service cooperation module 123.

In step S2204, the initial security level decision module 122 decides the security level as S. Any one of the initial security level decision flows illustrated in FIGS. 12 to 14 is used.

In step S2206, the security level management module 124 acquires the service cooperation information, which corresponds to a processing parameter and an item of the service menu input by an operation of the user, using the service menu correspondence table 127. A Web service is assumed to be performed by cooperation of W1 to Wn, and a designated parameter of each Web service is set to Pi.

In step S2208, the security level management module 124 performs security determination based on the service cooperation information and S. The security determination is performed according to the security determination flow of service cooperation illustrated in FIG. 15.

In step S2210, the security level management module 124 determines whether or not a result of the determination in step S2008 is O.K. When the determination result is O.K., the process proceeds to step S2226. In other cases, the process proceeds to step S2212.

In step S2212, the security level management module 124 updates S based on the result of security determination (step S2208 or step S2222).

In step S2214, the security level management module 124 acquires a service information group Ck (k: 1 to m), which is equal to the service Wi whose reliability is insufficient (that is, the reliability of the Web service does not satisfy the security level of processing data), using the compatible service table 126. In addition, the reliability Sk of a service of each service information group Ck is acquired using the Web service reliability table 131. It is checked whether or not a service, which satisfies the condition of Sk<S, is included in Ck.

In step S2216, the security level management module 124 determines whether or not there is any service of the processing result in step S2214. When there is a service of the processing result in step S2216, the process proceeds to step S2218. In other cases, the process proceeds to step S2224.

In step S2218, the security level management module 124 adds to S the degree of change of the corresponding equal Web service.

In step S2220, the security level management module 124 determines whether or not the variable i is equal to n. In the case of i=n, the process proceeds to step S2226. In other cases, the process proceeds to step S2222.

In step S2222, the security level management module 124 performs security determination using Wi+1 to Wn and S. The security determination is performed according to the security determination flow of service cooperation illustrated in FIG. 15. Then, the process returns to step S2210.

In step S2224, the input/output interface 121 performs error notification. Then, the process ends (step S2299).

In step S2226, the service cooperation module 123 executes the service cooperation processing flow illustrated in FIG. 16. Then, the process ends (step S2299).

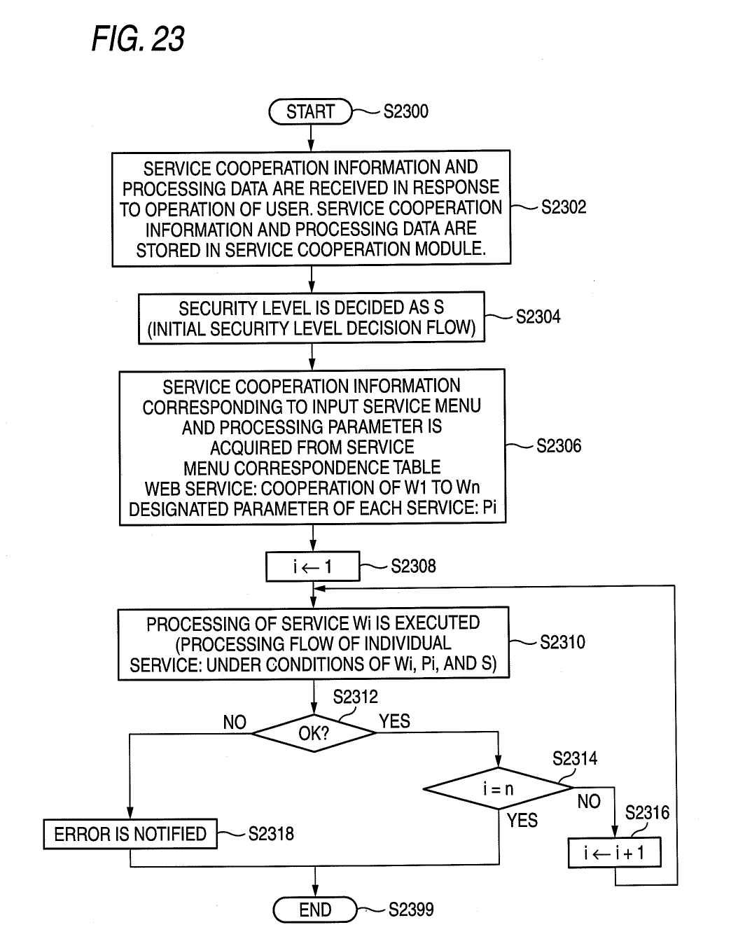

FIG. 23 is a flow chart showing a second service processing example in the third embodiment. This is a processing flow in which designation is performed using a service menu and a determination on whether or not a Web service with reliability, which does not satisfy the security level of processing data, is included is performed while performing actual processing.

In step S2302, the service cooperation module 123 receives the service cooperation information and the processing data in response to an operation of a user. The service cooperation information and the processing data are stored in the service cooperation module 123.

In step S2304, the initial security level decision module 122 decides the security level as S. Any one of the initial security level decision flows illustrated in FIGS. 12 to 14 is used.

In step S2306, the security level management module 124 acquires the service cooperation information, which corresponds to a processing parameter and an item of the service menu input by an operation of the user, using the service menu correspondence table 127. A Web service is assumed to be performed by cooperation of W1 to Wn, and a designated parameter of each Web service is set to Pi.

In step S2308, the security level management module 124 substitutes 1 into the variable i.

In step S2310, the service cooperation module 123 executes processing of the service Wi. The processing flow of an individual service illustrated in FIG. 19 is used under conditions of Wi, Pi, and S.

In step S2312, the security level management module 124 determines whether or not a result of the determination in step S2310 is O.K. When the determination result is O.K. (when a Web service is performed), the process proceeds to step S2314. In other cases, the process proceeds to step S2318.

In step S2314, the security level management module 124 determines whether or not the variable i is equal to n. When the variable i is equal to n, the process ends (step S2399). In other cases, the process proceeds to step S2316.

In step S2316, the security level management module 124 substitutes i+1 into the variable i. Then, the process returns to step S2310.

In step S2318, the input/output interface 121 performs error notification. Then, the process ends (step S2399).

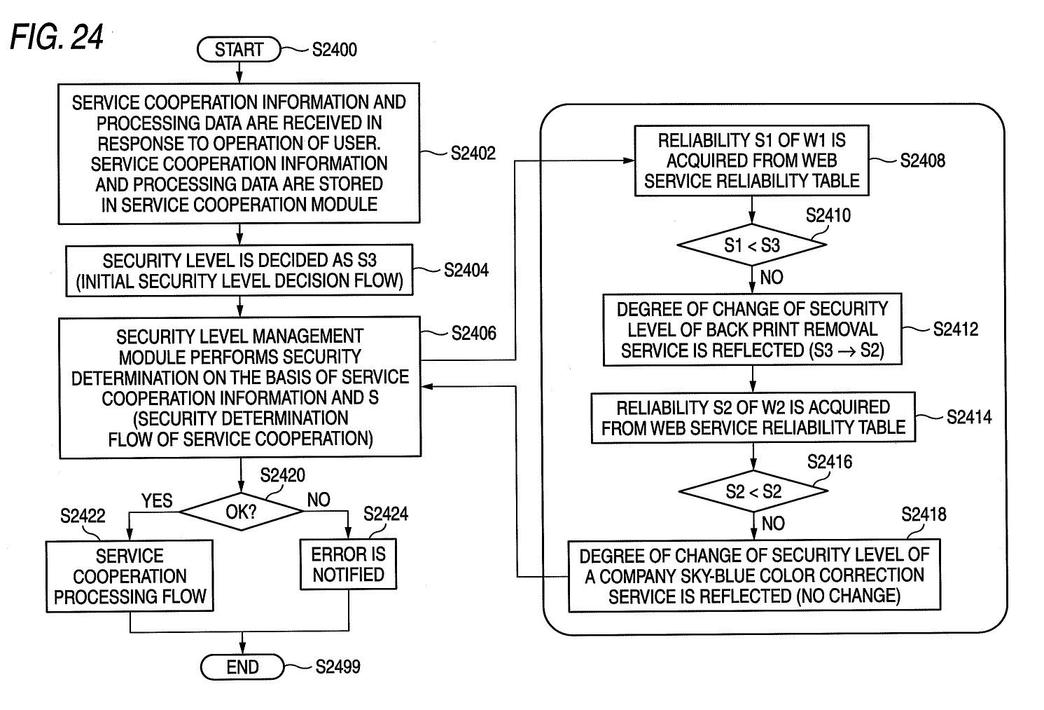

FIG. 24 is a flow chart showing a specific example of service processing. Here, using the flow chart illustrated in FIG. 11, processing of the A company sky-blue color correction service 150F is made to cooperate after performing the back print removal service 150C shown in FIG. 2. That is, this is an example where cooperative processing is performed. In addition, it is assumed that the back print removal service 150C is the Web service W1, the parameter is P1, the degree of change of the security level is +1, and the reliability is S1. In addition, it is assumed that the A company sky-blue color correction service 150F is the Web service W2, the parameter is P2, the degree of change of the security level is 0, and the reliability is S2.

In step S2402, the service cooperation module 123 receives the service cooperation information and the processing data in response to an operation of a user. The service cooperation information and the processing data are stored in the service cooperation module 123.

In step S2404, the initial security level decision module 122 decides the security level of processing data as S3. Any one of the initial security level decision flows illustrated in FIGS. 12 to 14 is used.

In step S2406, the security level management module 124 performs security determination based on the service cooperation information and S (S3). Processing in steps S2408 to S2418 is processing according to the security determination flow of service cooperation illustrated in FIG. 15.

In step S2408, the reliability S1 of W1 (back print removal service 150C) is acquired using the Web service reliability table 131. This corresponds to step S1504 in the flow chart illustrated in FIG. 15.

In step S2410, it is determined whether or not “reliability (S1) of Web service<security level (S3) of processing data” is satisfied. This corresponds to step S1506 in the flow chart illustrated in FIG. 15. Since S1<S3 is not satisfied, the process proceeds to step S2412.

In step S2412, the degree of change of the security level of the back print removal service 150C is reflected. That is, S3 is set to S2. This corresponds to step S1510 in the flow chart illustrated in FIG. 15.

In step S2414, the reliability S2 of W2 (A company sky-blue color correction service 150F) is acquired using the Web service reliability table 131. This corresponds to step S1504 in the flow chart illustrated in FIG. 15.

In step S2416, it is determined whether or not “reliability (S2) of Web service<security level (S2) of processing data” is satisfied. This corresponds to step S1506 in the flow chart illustrated in FIG. 15. Since S2<S2 is not satisfied, the process proceeds to step S2418.

In step S2418, the degree of change of the security level of the A company sky-blue color correction service 150F is reflected. That is, there is no change in the security level. This corresponds to step S1510 in the flow chart illustrated in FIG. 15. Then, the process returns to step S2406.

In step S2420, it is determined whether or not the processing result in step S2406 is O.K. Since the processing result in S2406 is O.K. in this processing, the process proceeds to step S2422.

In step S2422, a service cooperation processing flow illustrated in FIG. 16 is executed. Then, the process ends (step S2499).

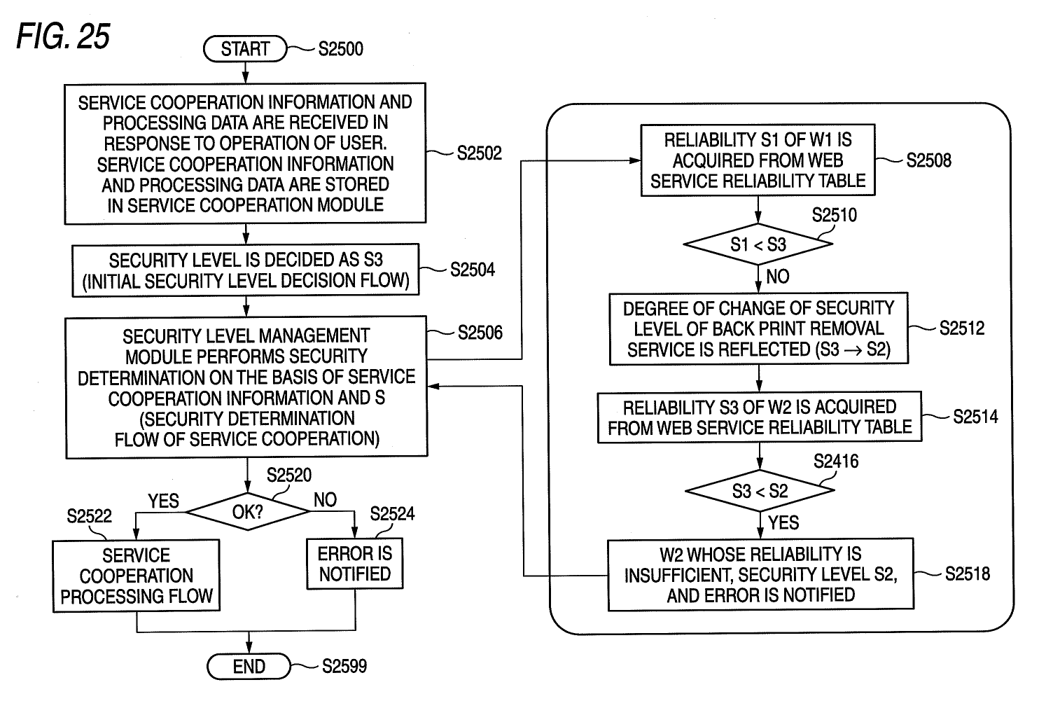

FIG. 25 is a flow chart showing a specific example of service processing. Here, using the flow chart illustrated in FIG. 11, processing of the C company face recognition service 150R is made to cooperate after performing the back print removal service 150C shown in FIG. 4. That is, this is an example where cooperative processing is not performed. In addition, it is assumed that the back print removal service 150C is the Web service W1, the parameter is P1, the degree of change of the security level is +1, and the reliability is S1. In addition, it is assumed that the C company face recognition service 150R is the Web service W2, the parameter is P2, the degree of change of the security level is +1, and the reliability is S3.

Processing in steps S2502 to S2506 is equal to the processing in steps S2402 to S2406 in the flow chart illustrated in FIG. 24.

In step S2508, the reliability S1 of W1 (back print removal service 150C) is acquired using the Web service reliability table 131. This corresponds to step S1504 in the flow chart illustrated in FIG. 15.

In step S2510, it is determined whether or not “reliability (S1) of Web service<security level (S3) of processing data” is satisfied. This corresponds to step S1506 in the flow chart illustrated in FIG. 15. Since S1<S3 is not satisfied, the process proceeds to step S2512.

In step S2512, the degree of change of the security level of the back print removal service 150C is reflected. That is, S3 is set to S2. This corresponds to step S1510 in the flow chart illustrated in FIG. 15.

In step S2514, the reliability S3 of W2 (C company face recognition service 150R) is acquired using the Web service reliability table 131. This corresponds to step S1504 in the flow chart illustrated in FIG. 15.

In step S2516, it is determined whether or not “reliability (S3) of Web service<security level (S2) of processing data” is satisfied. This corresponds to step S1506 in the flow chart illustrated in FIG. 15. Since S3<S2 is satisfied, the process proceeds to step S2518.

In step S2518, W2 (C company face recognition service 150R) whose reliability is insufficient (reliability of the Web service does not satisfy the security level of processing data), the security level S2, and an error is notified. This corresponds to step S1510 in the flow chart illustrated in FIG. 15. Then, the process returns to step S2506.

In step S2520, it is determined whether or not the processing result in step S2506 is O.K. Since the processing result in S2506 is not O.K. in this processing, the process proceeds to step S2524.

In step S2524, the input/output interface 121 performs error notification. Then, the process ends (step S2599).

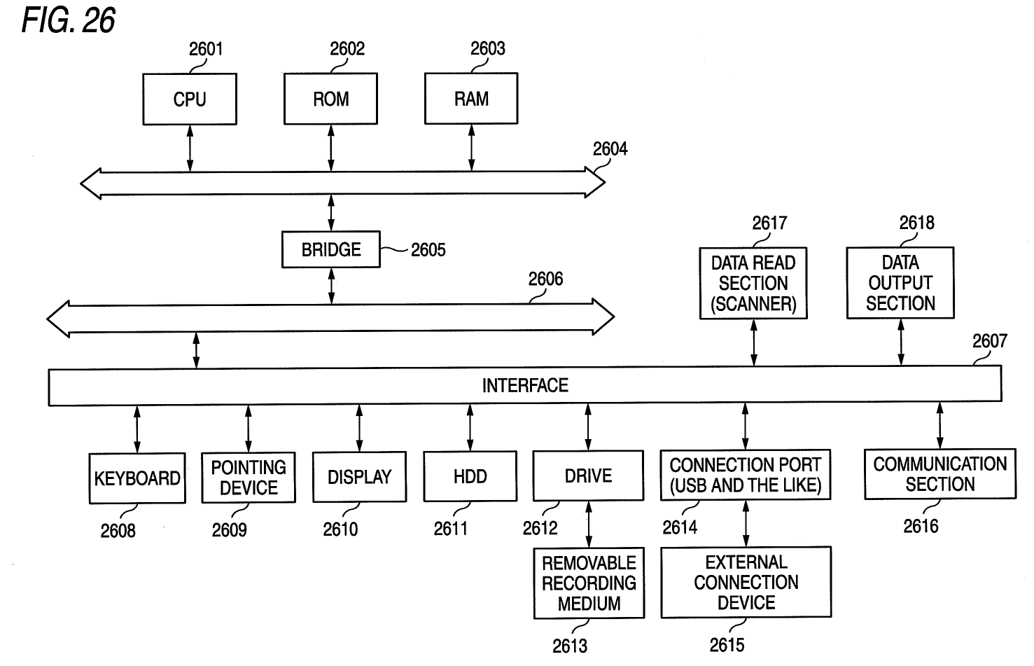

Referring to FIG. 26, an example of the hardware configuration of the information processing apparatus according to the present embodiment will be described. The configuration shown in FIG. 26 is formed by a personal computer (PC) and the like, for example. Here, an example of the hardware configuration including a data read section 2617, such as a scanner, and a data output section 2618, such as a printer, is shown.

A CPU (Central Processing Unit) 2601 is a control unit that executes processing according to a computer program in which the execution sequences of various modules described in the above embodiment, that is, the execution sequences of the initial security level decision module 122, the service cooperation module 123, and the security level management module 124 are written.

A ROM (Read Only Memory) 2602 stores a program, an operation parameter, and the like that the CPU 2601 uses. A RAM (Random Access Memory) 2603 stores a program used at the time of execution of the CPU 2601, a parameter that appropriately varies in the execution, and the like. These are connected to each other by a host bus 2604, such as a CPU bus.

The host bus 2604 is connected to an external bus 2606, such as a PCI (Peripheral Component Interconnect/Interface) bus, through a bridge 2605.

A keyboard 2608 and a pointing device 2609, such as a mouse, are input devices operated by an operator. A display 2610 is a liquid crystal display or a CRT (Cathode Ray Tube), for example, and displays various kinds of information as text or image information.

A HDD (Hard Disk Drive) 2611 includes a hard disk therein, drives the hard disk, and records or reproduces a program or information executed by the CPU 2601. Data to be processed, data of a processing result, and the like are stored in the hard disk. In addition, various computer programs, such as various kinds of other data processing programs, are stored.

A drive 2612 reads data or a program recorded in a mounted removable recording medium 2613, such as a magnetic disk, an optical disk, a magneto-optic disk, or a semiconductor memory, and supplies transmits the read data or program to the RAM 2603 connected thereto through an interface 2607, the external bus 2606, the bridge 2605, and the host bus 2604. The removable recording medium 2613 may also be used as the same data recording area as the hard disk.

A connection port 2614 is a port connected to an external connection device 2615 and has connecting portions, such as USB and IEEE 1394. The connection port 2014 is connected to the CPU 2601 and the like through the interface 2607, the external bus 2606, the bridge 2605, the host bus 2604, and the like. A communication section 2616 is connected to the network and executes processing for data communication with the outside. The data read section 2617 is a scanner, for example, and executes document reading processing. The data output section 2618 is a printer, for example, and executes document data output processing.

In addition, the hardware configuration of the information processing apparatus shown in FIG. 26 is an example of the configuration. A configuration that allows the modules explained in the present embodiment to be executable may be adopted in the present embodiment without being limited to the configuration shown in FIG. 26. For example, some of the modules may be formed by using dedicated hardware (for example, Application Specific Integrated Circuit (ASIC)). In addition, some of the modules may be provided in an external system connected through a communication line. Alternatively, a plurality of systems shown in FIG. 26 may be connected to each other through a communication line so as to perform a cooperative operation. Moreover, the modules may be included in a copying machine, a facsimile, a scanner, a printer, a complex machine (image processing apparatus having two or more functions of a scanner, a printer, a copying machine, and a facsimile), and the like.

In addition, the various kinds of embodiments described above may be combined (for example, a case where a module in a certain embodiment is applied or replaced in another embodiment is also included), and the technique described in the Background Art may be adopted as processing contents of each module.

Moreover, in comparisons of the value set beforehand in the explanations of the embodiments, “equal to or larger than”, “equal to or smaller than”, “larger than”, and “smaller than (less than)” may be interpreted as “larger than”, “smaller than (less than)”, “equal to or larger than”, and “equal to or smaller than” if there is no contradiction in the combination.

In addition, the program described above may be provided in a state where the program is stored in a recording medium or the program may be provided through a communication unit. In this case, the program may be regarded as the invention of a “computer-readable recording medium in which a program is recorded”, for example.

The “computer-readable recording medium in which a program is recorded” refers to a recording medium that can be read by a computer recorded with a program, which is used for installation, execution, distribution, and the like of the program.

In addition, examples of recording media include: in association with a digital versatile disk (DVD), “DVD-R, DVD-RW, DVD-RAM, and the like” that are standards established by a DVD forum and “DVD+R, DVD+RW, and the like” that are standards established by a DVD+RW forum; in association with a compact disk (CD), a read only memory (CD-ROM), a CD recordable (CD-R), and a CD rewritable (CD-RW), and the like; a Blu-ray disk (registered trademark); a magneto-optic disk (MO); a flexible disk (FD); a magnetic tape; a hard disk; a read only memory (ROM); an electrically erasable and programmable read only memory (EEPROM); a flash memory; and a random access memory (RAM).

In addition, the program or a part of the program may be stored or distributed in a state where the program or part of the program is recorded in the recording media. In addition, the program may be transmitted by communication, for example, through a wire line network such as a local area network (LAN), a metropolitan area network (MAN), a wide area network (WAN), Internet, an intranet, and an extranet or through a wireless communication network. Alternatively, the program may be transmitted through a transmission medium obtained by combination of those described above or may be carried on a carrier.

In addition, the program may be a part of another program or may be recorded on a recording medium together with a separate program. In addition, the program may be separated and recorded in a plurality of recording media. In addition, the program may be recorded in any kind of format including compression, encryption, and the like as long as the program can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reliability decision unit that decides reliability, which is required in order to process a processing object, based on the processing object;
a processing determination unit that determines whether or not to make a processing subject process the processing object by comparing the reliability determined by the reliability decision unit with reliability of the processing subject; and
a processing request unit that requests processing of the processing object to the processing subject when the processing determination unit determines that the processing object is to be processed by the processing subject.

2. The information processing apparatus according to claim 1,
wherein when a plurality of processing subjects is required in order to perform the processing, the processing determination unit determines before performing the processing as to whether or not make each of the plurality of processing subjects process the processing object.

3. The information processing apparatus according to claim 1,
wherein when a plurality of processing subjects is required in order to perform the processing, the processing determination unit determines whether or not to make the next processing subject process the processing object whenever processing by each of plurality of processing subjects ends.

4. The information processing apparatus according to claim 1, further comprising:
a processing subject correspondence storage unit that stores a processing subject and another corresponding processing subject,
wherein when it is determined that there is no processing subject capable of processing the processing object, the processing determination unit determines whether or not to make said another processing subject corresponding to the processing subject, which is stored in the processing subject correspondence storage unit, process the processing object.

5. The information processing apparatus according to claim 1, further comprising:
an item correspondence storage unit that stores items and corresponding processing subjects,
wherein the processing determination unit determines whether or not to make a processing subject, which corresponds to one of the items selected based on an operation of a user and is stored in the item correspondence storage unit, process the processing object.

6. The information processing apparatus according to claim 1,
wherein a plurality of processing subjects is required in order to perform the processing, the processing determination unit before performing the processing, determines as to whether or not the plurality of processing subjects contains a processing subject having reliability lower than the reliability determined by the reliability decision unit.

7. The information processing apparatus according to claim 1,
wherein when a plurality of processing subjects is required in order to perform the processing, the processing determination unit determines as to whether or not the next processing subject has reliability greater than or equal to the reliability determined by the reliability decision unit whenever processing by each of plurality of processing subject ends.

8. An information processing method comprising:
deciding reliability, which is required in order to process a processing object, based on the processing object;
determining whether or not to make a processing subject process the processing object by comparing the determined reliability with reliability of the processing subject; and
requesting processing of the processing object to the processing subject when the processing determination unit determines that the processing object is to be processed by the processing subject.

9. A computer readable medium storing a program causing a computer to execute a process for information processing, the process comprising:
deciding reliability, which is required in order to process a processing object, based on the processing object;
determining whether or not to make a processing subject process the processing object by comparing the determined reliability with reliability of the processing subject; and
requesting processing of the processing object to the processing subject when the processing determination unit determines that the processing object is to be processed by the processing subject.
